(19) United States
(12) Patent Application Publication
(10) Pub. No.: US 2005/0183011 A1
(43) Pub. Date: Aug. 18, 2005

(54) Method and apparatus for managing modification of content in a document

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/777,716

(22) Filed: Feb. 12, 2004

(51) Int. Cl. G06F 17/21

(52) U.S. Cl. 715/539; 715/540

(57) ABSTRACT

A method, apparatus, and computer instructions for modifying a document. A determination is made as to whether a portion of the selected content is protected from deletion. This determination is made in response to receiving a user input to delete selected content within the document. Deletion of the portion of the selected content is prevented in response to the portion of the selected content being protected. In some cases, the portion may be deleted after receiving a second user input confirming the deletion.

### BACKGROUND OF THE INVENTION

1. Technical Field

The present invention relates generally to an improved data processing system and in particular, a method and apparatus for processing data. Still more particularly, the present invention provides a method, apparatus, and computer instructions for managing deletion of content in a document.

2. Description of Related Art

The increased utilization of computers and other electronic communication devices at home, in businesses, and between businesses has expanded dramatically, as a result of the similar expansion in the amount of software and information available. Examples of different types of software include word processors, spreadsheet programs, Web design programs, and publishing programs.

With this communication between different users, it is common for two or more users to work together on or collaborate on documents generated from these types of programs. A common method for collaboration is for users to transfer copies of a document back and forth via email, shared network drives, floppy disks, or any other file transfer method. When a user receives the document, the user may make changes to the document. These changes may include additions or deletions to the content in the document. Further, a user may add comments to the content in the document. These changes are often made using a red-line strikeout function present in the program used to make the modifications. These changes are then returned to the other users participating in the collaboration on the document. Common applications of this include contracts, manuscripts, memorandum, Web pages, computer source code, and financial spreadsheets.

In some cases, one user in the collaborative effort may see content that was deleted that the user wants to remain in the document. Currently, the user must undelete the comment and resend the document back to the other users in the collaborative group. Such a procedure increases the number of revisions and time needed to complete a document. Therefore, it would be advantageous to have an improved method, apparatus, and computer instructions for managing the deletion of content in a document.

### SUMMARY OF THE INVENTION

The present invention provides a method, apparatus, and computer instructions for modifying a document. A determination is made as to whether a portion of the selected content is protected from deletion. This determination is made in response to receiving a user input to delete selected content within the document. Deletion of the portion of the selected content is prevented in response to the portion of the selected content being protected. In some cases, the portion may be deleted after receiving a second user input confirming the deletion.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in managing deletion of content in a document in accordance with a preferred embodiment of the present invention;

FIG. 5 is a diagram illustrating an exemplary display containing an indication of protected content in accordance with a preferred embodiment of the present invention;

FIG. 6 is a flowchart of a process for marking content in accordance with a preferred embodiment of the preset invention; and

FIG. 7 is a flowchart of a process for managing deletion of content in accordance with a preferred embodiment of the preset invention.

### DETAILED DESCRIPTION OF THE PREFERRED EMBODIMENT

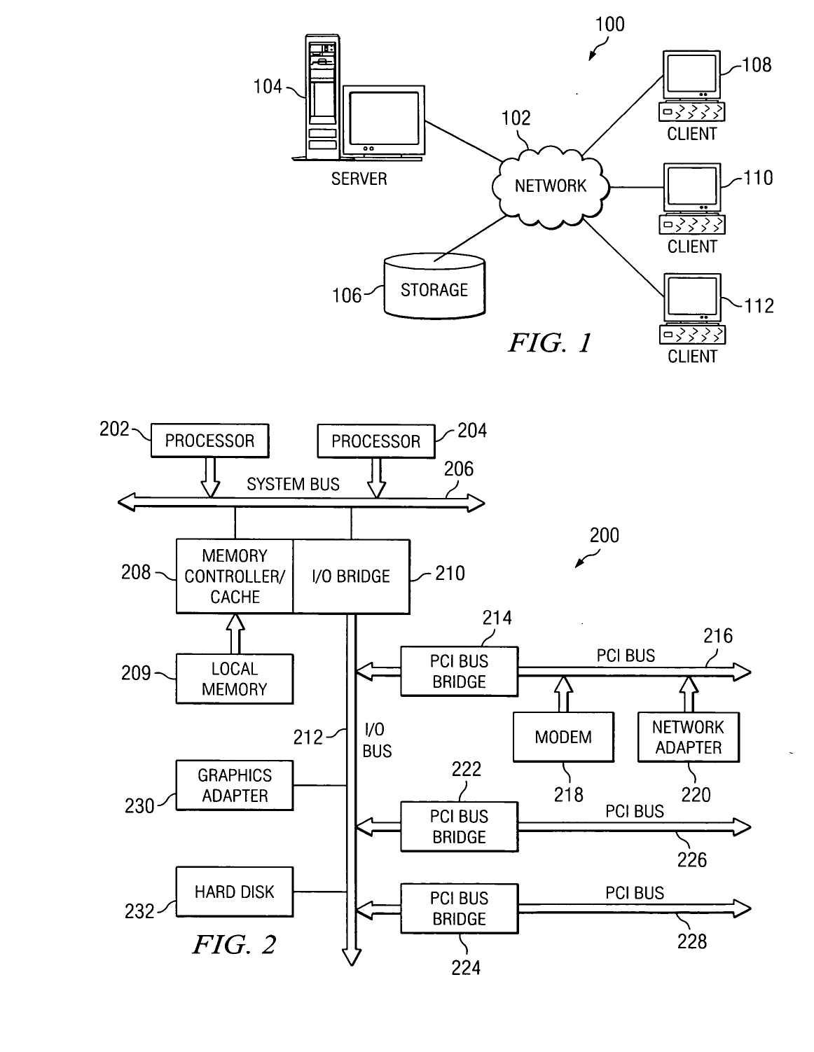

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In these illustrative examples, users at clients 108, 110, and 112 may work together in a collaborative effort to create a document. This document may be, for example, a Web page, a spreadsheet, or a word processing document. This effort may involve sending the document back and forth to each other with edits made by the users. Alternatively, the collaborative effort may be online such that the users may all edit the document at the same time. In this case, the document may be located on server 104. The present invention provides a method, apparatus, and computer instructions for managing deletions of content that a user may wish to prevent.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

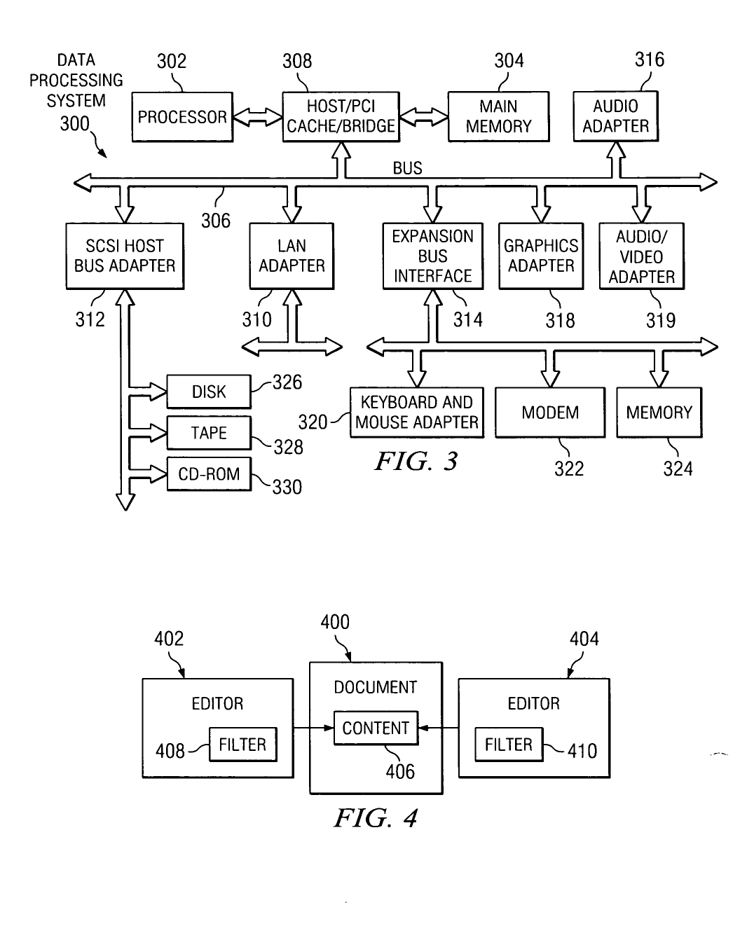

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention recognizes that in some cases a user may wish to prevent another user from deleting content in a document. Content may include, for example, text or graphical images. The present invention provides a method, apparatus, and computer instructions for managing deletion of content in a document. As used herein, a deletion includes any user input that removes user content from a document. For example, a delete and a cut function in a word processor both result in a deletion of content. A first user may select or mark content, such as a section of text that is to be protected from deletion. This section of text may be, for example, a key word, a sentence, or a paragraph. Other contents, such as a graphic image, may be selected for protection from deletion using the mechanism of the present invention. A second user selecting content that includes the section of text that has been marked as being protected from deletion is protected from deleting the text.

In response to receiving a user input selecting content that includes the section of text, an indication that the section of text is protected from deletion may be presented to the user. For example, a pop-up window presenting a message stating “inserted by user A. Do you want to delete?” may be displayed. The second user may delete the text only after confirming the deletion.

Turning next to FIG. 4, a diagram illustrating components used in managing deletion of content in a document is depicted in accordance with a preferred embodiment of the present invention. In this example, document 400 is being modified in a collaborative effort between users using editor 402 and editor 404.

In these illustrative examples, document 400 may take various forms. For example, document 400 may be a word processing document, a spreadsheet, a Web page, or computer code. This document may be one that is passed back and forth between editor 402 and editor 404. Alternatively, document 400 may be modified by both editor 402 and editor 404 at the same time. These editors may be implemented using any program or application used to modify content. Editor 402 and editor 404 may be, for example, a word processor or a spreadsheet program.

In this example, content 406 may have been inserted using editor 402. By inserting content 406 in document 400, this content may be automatically marked for protection from deletion. Alternatively, editor 402 may be used to mark content 406 as content being protected from deletion, regardless of whether content 406 was inserted using editor 402. Content may be marked in a number of different ways. For example, the text may be highlighted with the user then pressing a right mouse button to display options, including an option to protect the text. This text is then marked using a code, such as a hidden tag that identifies the text as that being protected from deletion.

When content is selected for deletion, a filter, such as filter 408 in editor 402 or filter 410 in editor 404 is used to determine whether content 406 has been selected as part of the content for deletion. These filters may be implemented using any filtering or parsing process that can identify content that has been marked for protection. In these examples, filter 408 and filter 410 may be implemented using a grep filter. This type of filter is a utility provided in UNIX. A grep filter searches line by line for a specific pattern and outputs any line that matches the pattern. In these examples, the pattern may be a hidden code used to mark text as being protected from deletion.

For example, if a user input is received by editor 404 to delete content, filter 410 parses the content for a marker or code that identifies the content or a portion of the content selected for deletion as being protected from deletion. If content 406 is present in the content selected for deletion, editor 404 does not delete content 406.

Instead, an indicator is presented by editor 404 to the user indicating that the content has been marked as being protected from deletion. This indicator may be, for example, highlighting the protected text or using a pop-up window or other display mechanism to identify the protected text. The user may confirm the deletion in these illustrative examples through a second user input. At that time, editor 404 deletes content 406 along with the rest of the content selected for deletion.

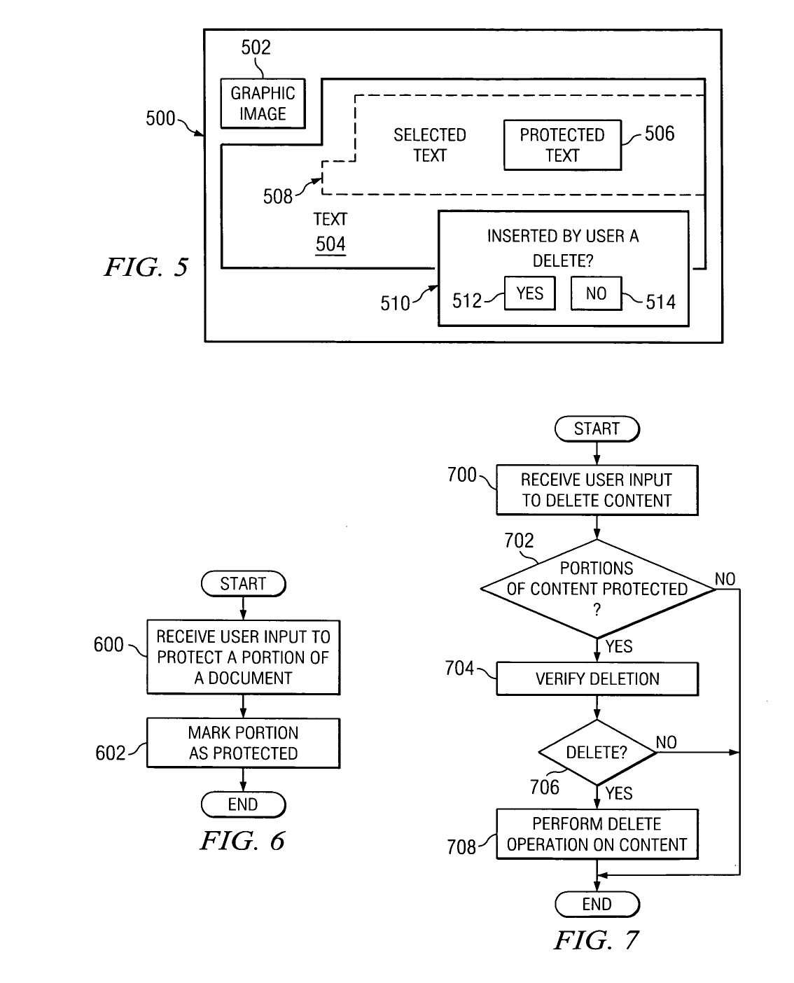

Turning next to FIG. 5, a diagram illustrating an exemplary display containing an indication of protected content is depicted in accordance with a preferred embodiment of the present invention. In this example, document 500 includes graphic image 502 and text 504. Protected text 506 contains text that has been marked as being protected from deletion. Selected text 508 is the portion of text 504 that has been selected for deletion. When a user input is received to delete selected text 508, content within selected text 508 is examined to determine whether text marked as being protected from deletion is present.

In this example, protected text 506 is present within selected text 508. In response to a user input to delete selected text 508, in this case, the deletion is prevented. Instead, an indicator, such as pop-up window 510 is presented. This pop-up window includes a statement “inserted by user A. Delete?”. The user may confirm the deletion by selecting yes button 512 and may cancel the deletion by selecting no button 514. Further, an indication through the use of blinking text or highlighted text in protected text 506 may be used to identify the text that has been marked as being protected from deletion.

If the user confirms the deletion selected text 508, including protected text 506, is deleted. Depending on the implementation, deletion of protected text 506 may be protected from occurring regardless of the user input.

With reference now to FIG. 6, a flowchart of a process for marking content is depicted in accordance with a preferred embodiment of the preset invention. The process illustrated in FIG. 6 may be implemented in an editor, such as editor 402 in FIG. 4.

The process begins by receiving user input to protect a portion of content in a document (step 600). This user input may take various forms. For example, the insertion of text may form the user input to protect the text as the portion of the content that should not be deleted. Alternatively, the user input may be one in which the portion of content is highlighted or selected by the user with an appropriate command to indicate that the text is to be protected from deletion. Graphic images may be protected in a similar fashion.

Next, the portion of content is marked as protected (step 602) with the process terminating thereafter. In these illustrative examples, the portion of the content in the document may be marked using hidden codes that mark the beginning and the end of the content that is to be protected from deletion.

With reference now to FIG. 7, a flowchart of a process for managing deletion of content is depicted in accordance with a preferred embodiment of the preset invention. The process illustrated in FIG. 7 may be implemented in an editor, such as editor 402 in FIG. 4.

The process begins by receiving a user input to delete content (step 700). This input, may be, for example, a selection of content made by the user along with a command to delete the selected content. Next, a determination is made as to whether one or more portions of the selected content are marked as being protected from deletion (step 702). Step 702 may be implemented by parsing or filtering the content to determine whether indicators, such as hidden codes identify one or more portions of the selected content as being protected from deletion. If one or more portions of content are protected, then the deletion is verified (step 704). This verification may be initiated through the use of a pop-up window, such as pop-up window 510 in FIG. 5.

Then, a determination is made as to whether a deletion should be made (step 706). This determination may be made by determining whether another user input is received, confirming the deletion. If the deletion is to be made, a delete operation is performed on the content (step 708) with the process terminating thereafter.

Referring back to step 702, if portions of content are not protected then the process terminates. In step 706, if a deletion is not performed, then the process terminates.

Thus, the present invention provides a method, apparatus, and computer instructions for managing modifications to content in a document. The content may be marked as being protected from deletion. If a user input attempts to delete content including a protected content, the deletion does not occur. Instead, an indication may be presented to identify the content that has been protected from deletion. Depending on the implementation, the deletion may occur after a second user input has been received confirming the deletion. In other implementations, the deletion does not occur at all.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for modifying a document, the method comprising:
responsive to receiving a user input to delete selected content within the document, determining whether a portion of the selected content is protected from deletion; and
responsive to the portion of the selected content being protected, preventing deletion of the portion of the selected content.

2. The method of claim 1, wherein the user input is a first user input and further comprising:
responsive to a second user input confirming deletion of the portion of the selected content, allowing deletion of the portion of the selected content to proceed.

3. The method of claim 1, wherein the preventing step includes:
generating an indication that the portion of the selected content is protected content.

4. The method of claim 3, wherein the indication includes at least one of highlighting the protected content and causing the protected content to blink.

5. The method of claim 1, wherein the portion of the selected content is at least one of text and a graphic image.

6. The method of claim 1, wherein the determining step includes using a grep filter to identify the portion of the selected content.

7. A data processing system for modifying a document, the data processing system comprising:
determining means, responsive to receiving a user input to delete selected content within the document, for determining whether a portion of the selected content is protected from deletion; and
preventing means, responsive to the portion of the selected content being protected, for preventing deletion of the portion of the selected content.

8. The data processing system of claim 7, wherein the user input is a first user input and further comprising:
allowing means, responsive to a second user input confirming deletion of the portion of the selected content, for allowing deletion of the portion of the selected content to proceed.

9. The data processing system of claim 7, wherein the preventing means includes:
generating means for generating an indication that the portion of the selected content is protected content.

10. The data processing system of claim 9, wherein the indication includes at least one of highlighting the protected content and causing the protected content to blink.

11. The data processing system of claim 7, wherein the portion of the selected content is at least one of text and a graphic image.

12. The data processing system of claim 7, wherein the determining means includes using a grep filter to identify the portion of the selected content.

13. A computer program product in a computer readable medium for modifying a document, the computer program product comprising:
first instructions, responsive to receiving a user input to delete selected content within the document, for determining whether a portion of the selected content is protected from deletion; and
second instructions, responsive to the portion of the selected content being protected, for preventing deletion of the portion of the selected content.

14. The computer program product of claim 13, wherein the user input is a first user input and further comprising:
third instructions, responsive to a second user input confirming deletion of the portion of the selected content, for allowing deletion of the portion of the selected content to proceed.

15. The computer program product of claim 13, wherein the second instructions includes:
sub-instructions for generating an indication that the portion of the selected content is protected content.

16. The computer program product of claim 15, wherein the indication includes at least one of highlighting the protected content and causing the protected content to blink.

17. The computer program product of claim 13, wherein the portion of the selected content is at least one of text and a graphic image.

18. The computer program product of claim 13, wherein the first instructions includes using a grep filter to identify the portion of the selected content.

19. A data processing system comprising:
a bus system;
a memory connected to the bus system, wherein the memory includes a set of instructions; and
a processing unit connected to the bus system, wherein the processing unit executes a set of instructions to determine whether a portion of selected content is protected from deletion in response to receiving a user input to delete selected content within a document; and prevent deletion of the portion of the selected content in response to the portion of the selected content being protected.

20. A data processing system of claim 19, wherein the processing unit further executes to allow deletion of the portion of the selected content to proceed in response to a second user input confirming deletion of the portion of the selected content.
